(19) United States
(12) Patent Application Publication
(10) Pub. No.: US 2010/0076764 A1
(43) Pub. Date: Mar. 25, 2010

(54) METHOD OF DIALING PHONE NUMBERS USING AN IN-VEHICLE SPEECH RECOGNITION SYSTEM

(75) Inventor: Rathinavelu Chengalvarayan, Naperville, IL (US)

Correspondence Address: General Motors Corporation;c/o REISING, ETHINGTON, BARNES, KISSELLE, P.C., P.O. BOX 4390, TROY, MI, 48099-4390, US

(73) Assignee: General Motors Corporation, Detroit, MI (US)

(21) Appl. No.: 12/234,217

(22) Filed: Sep. 19, 2008

(51) Int. Cl. G10L 15/00; G10L 21/00

(52) U.S. Cl. 704/251; 704/275; 455/563; 704/E15.005

(57) ABSTRACT

A method of dialing phone numbers using an in-vehicle speech recognition system includes receiving speech input at a vehicle, separating the speech input into a word segment and a digit segment, identifying the letters in a word segment, converting the letters in the word segment to digits, and operating an alphanumeric keypad based on the digit speech segment and the converted word segment.

### TECHNICAL FIELD

The present invention relates generally to speech recognition systems and more particularly to in-vehicle dialing using a speech recognition system in a vehicle.

### BACKGROUND OF THE INVENTION

Automatic Speech Recognition (ASR) technologies enable microphone-equipped computing devices to interpret speech and thereby provide an alternative to conventional human-to-computer input devices such as keyboards or keypads. Many telecommunications devices are equipped with ASR technology to detect the presence of discrete speech such as a spoken nametag or control vocabulary like numerals, keywords, or commands. For example, ASR can match a spoken command word with a corresponding command stored in memory of the telecommunication device to carry out some action, like dialing a telephone number. Also, an ASR system is typically programmed with predefined acceptable vocabulary that the system expects to hear from a user at any given time, known as in-vocabulary speech. For example, during a voice dialing mode, the ASR system may expect to hear keypad vocabulary such as “Zero” through “Nine,” “Pound,” and “Star,” as well as ubiquitous command vocabulary such as “Help,” “Cancel,” and “Goodbye.”

One problem encountered using ASR is when a user wishes to dial a number using a voice dialing mode that includes both words and numbers. For example, when the user wishes to dial a “1-800” number followed by a word such as “OnStar,” the user may have to enunciate the digits “1-800-4” and then mentally correlate the telephonic numerical equivalent of the word “OnStar.” Attempting to decipher the numerical equivalent of OnStar while engaging in an activity requiring concentration, such as operating a vehicle, is taxing on the user. Ultimately, any string of words and digits can benefit from automatically converting the words into a digit string without depending on the user's mental acuity.

### SUMMARY OF THE INVENTION

According to an aspect of the invention, there is provided a method of dialing phone numbers using an in-vehicle speech recognition system. The method includes (a) receiving speech input at a vehicle; (b) separating the speech input into a word segment and a digit segment; (c) identifying the letters in a word segment; (d) converting the letters in the word segment to digits; and (e) operating an alphanumeric keypad based on the digit speech segment and the converted word segment.

According to another aspect of the invention, there is provided a method of dialing phone numbers using an in-vehicle speech recognition system. The method includes (a) receiving speech input at a vehicle; (b) separating the speech input into a plurality of word segments and digit segments; (c) recording the order of the word segments and digit segments; (d) identifying the letters in a word segment; (e) converting the letters in the word segment to a digit segment; (f) organizing the digit segments and converted word segments into a single string of digits, where the sequence of the single string of digits is based on the recorded order of the word segments and digit segments; and (g) dialing a telephone number using the single string of digits.

According to another aspect of the invention, there is provided a method of dialing phone numbers using an in-vehicle speech recognition system. The method includes (a) receiving speech input at a vehicle; (b) separating the speech input into a plurality of word segments and digit segments; (c) recording the order of the word segments and digit segments; (d) comparing the plurality of word segments with the content of a vocabulary database, wherein the database contains nametags stored with a string of digits, and stored word segments; (e) if the word segment matches a nametag stored in the vocabulary database, translating the word segment into the string of digits; (f) if a separated word segment matches a stored word segment, translating the letters of the separated word segment into digits corresponding to the letters of an alphanumeric keypad; (g) requesting user input if the vocabulary database fails to recognize a word segment; (h) organizing the translated digit segments and converted word segments into a single string of digits, wherein the sequence of the single string of digits is based on the recorded order of the word segments and digit segments; and (j) dialing a telephone number using the single string of digits.

### BRIEF DESCRIPTION OF THE DRAWINGS

One or more preferred exemplary embodiments of the invention will hereinafter be described in conjunction with the appended drawings, wherein like designations denote like elements, and wherein:

FIG. 1 is a block diagram depicting an exemplary embodiment of a communications system that is capable of utilizing the method disclosed herein;

FIG. 2 is a block diagram depicting an exemplary embodiment of an automatic speech recognition system; and

FIG. 3 is a flow chart of an exemplary embodiment of a method of dialing phone numbers using an in-vehicle speech recognition system.

### DETAILED DESCRIPTION OF THE PREFERRED EMBODIMENT(S)

The method described below enables use of a speech recognition system to voice dial alphanumeric strings. As discussed above, the alphanumeric strings include telephone numbers represented by numbers and words. Generally speaking, the method involves separating the received speech input into word segments and digit segments. The method can be described using an example. For instance, the previously mentioned telephone number “1-800-4-OnStar” includes a number segment of “1-800-4” and a word segment of “OnStar.” When separating the digit segments and number segments, the method can remember the order of the segments. In the present example, the number segment is positioned first and the word segment is positioned second. After the method separates the digit and word segments, the method identifies the individual letters in a word segment.

The method can recognize that the word segment “OnStar” has six letters and can separate the letters into a string of letters “O-N-S-T-A-R.” Using the separated letters, the method can convert the letters of the word segment to digits. The method can accomplish letter-to-digit mapping based on a dual-tone-multi-frequency keypad. The DTMF keypad utilizes 12 keys using 10 digits and 2 characters. Eight of the digits have a range of alphabetic characters assigned to them. The button using “2” represents “ABC,” “3” represents “DEF,” “4” represents “GHI,” “5” represents “JKL,” “6” represents “MNO,” “7” also represents “PQRS,” “8” represents “TUV,” and “9” represents “WXYZ.” Using the DTMF keypad as a guide, and considering the above example, the method can convert the “O” to a “7,” the “N” to a “7,” the “S” to an “8,” the “T” to a “9,” the “A” to a “3,” and the “R” to an “8.” The conversion of letters to digits can also be referred to as deciphering. After converting the letters to digits, the method can assemble the converted letters into a second digit string “77893.” Using the first digit string “1-800-4” and the second digit string “77893,” the method can physically or electrically operate an alphanumeric keypad or dial a number based on the first digit speech segment and the converted word segment, or second digit segment.

### Communications System

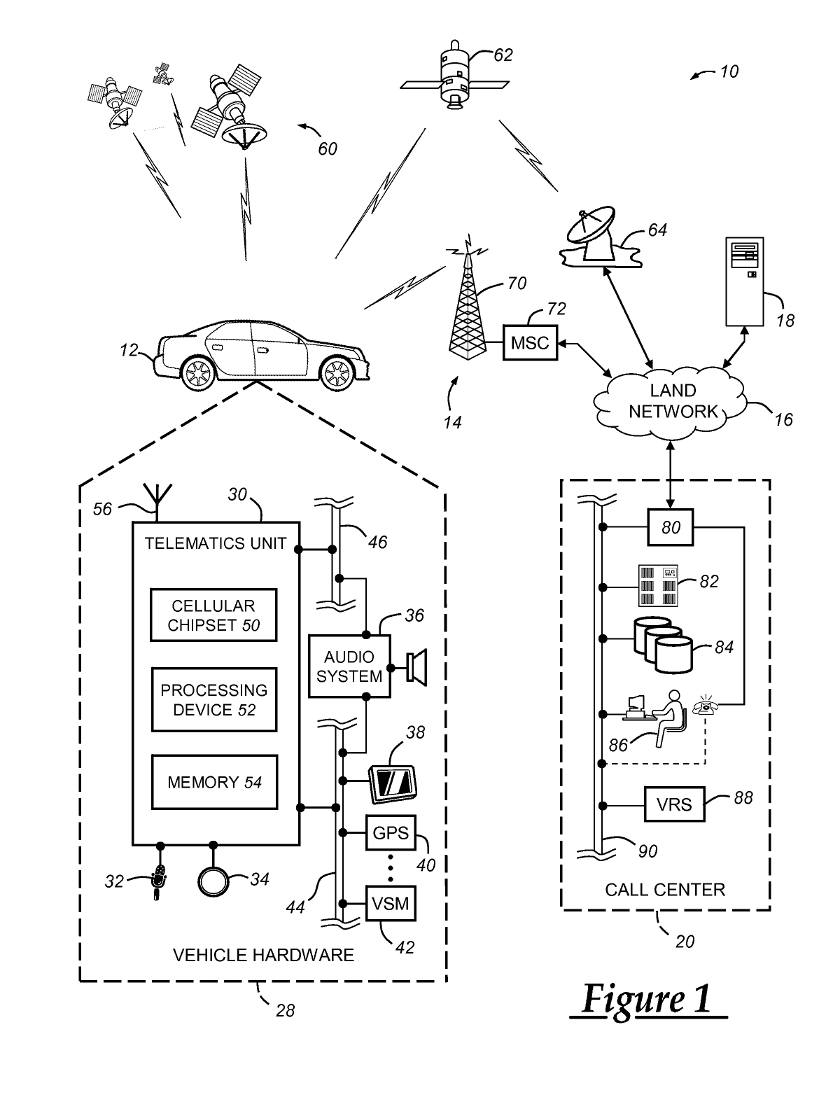

With reference to FIG. 1, there is shown an exemplary operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such exemplary system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is an OEM-installed device that enables wireless voice and/or data communication over wireless carrier system 14 and via wireless networking so that the vehicle can communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Exemplary ASR System

In general, a vehicle occupant vocally interacts with an automatic speech recognition system (ASR) for one or more of the following fundamental purposes: training the system to understand a vehicle occupant's particular voice; storing discrete speech such as a spoken nametag or a spoken control word like a numeral or keyword; or recognizing the vehicle occupant's speech for any suitable purpose such as voice dialing, menu navigation, transcription, service requests, or the like. Generally, ASR extracts acoustic data from human speech, compares and contrasts the acoustic data to stored subword data, selects an appropriate subword which can be concatenated with other selected subwords, and outputs the concatenated subwords or words for post-processing such as dictation or transcription, address book dialing, storing to memory, training ASR models or adaptation parameters, or the like. Subwords will hereinafter also be described as word segments and the terms can be used interchangeably.

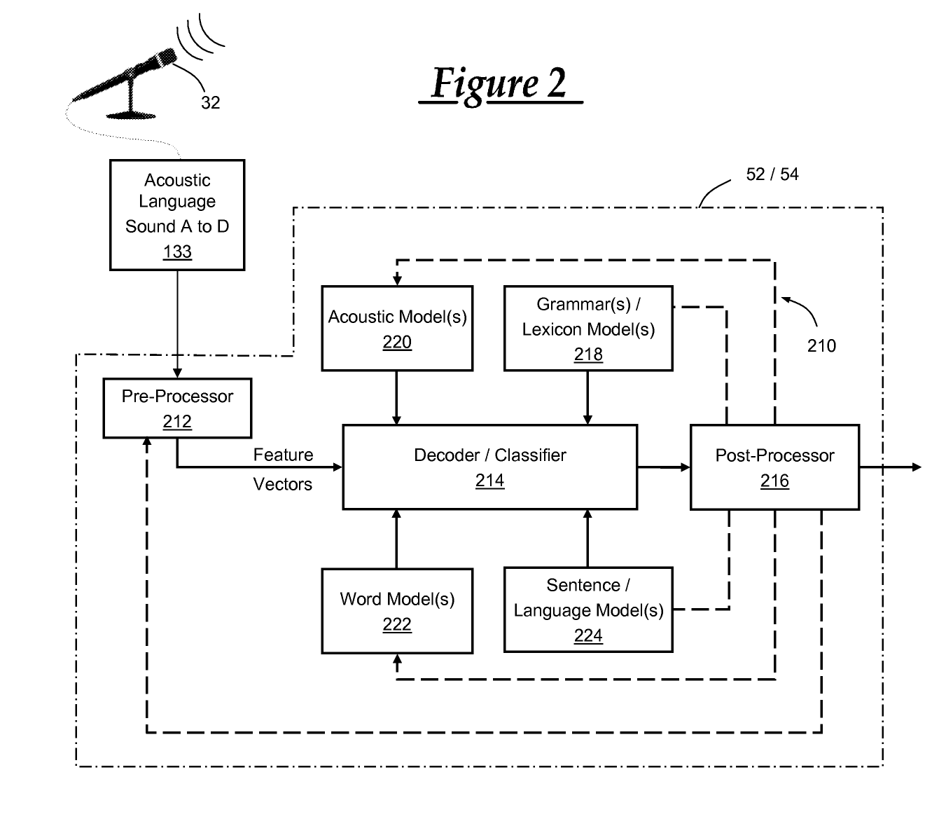

ASR systems are generally known to those skilled in the art, and FIG. 2 illustrates a specific exemplary architecture for an ASR system 210 that can be used to enable the presently disclosed method. The system 210 includes a device to receive speech such as the telematics microphone 32, and an acoustic interface 133 such as a sound card of the telematics user interface 128 to digitize the speech into acoustic data. The system 210 also includes a memory such as the telematics memory 54 for storing the acoustic data and storing speech recognition software and databases, and a processor such as the telematics processor 52 to process the acoustic data. The processor functions with the memory and in conjunction with the following modules: a front-end processor or pre-processor software module 212 for parsing streams of the acoustic data of the speech into parametric representations such as acoustic features; a decoder software module 214 for decoding the acoustic features to yield digital subword or word output data corresponding to the input speech utterances; and a post-processor software module 216 for using the output data from the decoder module 214 for any suitable purpose.

One or more modules or models can be used as input to the decoder module 214. First, grammar and/or lexicon model(s) 218 can provide rules governing which words can logically follow other words to form valid sentences. In a broad sense, a grammar can define a universe of vocabulary the system 210 expects at any given time in any given ASR mode. For example, if the system 210 is in a training mode for training commands, then the grammar model(s) 218 can include all commands known to and used by the system 210. In another example, if the system 210 is in a main menu mode, then the active grammar model(s) 218 can include all main menu commands expected by the system 210 such as call, dial, exit, delete, directory, or the like. Second, acoustic model(s) 220 assist with selection of most likely subwords or words corresponding to input from the pre-processor module 212. Third, word model(s) 222 and sentence/language model(s) 224 provide rules, syntax, and/or semantics in placing the selected subwords or words into word or sentence context. Also, the sentence/language model(s) 224 can define a universe of sentences the system 210 expects at any given time in any given ASR mode, and/or can provide rules, etc., governing which sentences can logically follow other sentences to form valid extended speech.

According to an alternative exemplary embodiment, some or all of the ASR system 210 can be resident on, and processed using, computing equipment in a location remote from the vehicle 12 such as the call center 20. For example, grammar models, acoustic models, and the like can be stored in memory of one of the servers 82 and/or databases 84 in the call center 20 and communicated to the vehicle telematics unit 30 for in-vehicle speech processing. The models described herein may also be referred to as vocabulary databases. Similarly, speech recognition software can be processed using processors of one of the servers 82 in the call center 20. In other words, the ASR system 210 can be resident in the telematics unit 30 or distributed across the call center 20 and the vehicle 12 in any desired manner.

First, acoustic data is extracted from human speech wherein a vehicle occupant speaks into the microphone 32, which converts the utterances into electrical signals and communicates such signals to the acoustic interface 133. A sound-responsive element in the microphone 32 captures the occupant's speech utterances as variations in air pressure and converts the utterances into corresponding variations of analog electrical signals such as direct current or voltage. The acoustic interface 133 receives the analog electrical signals, which are first sampled such that values of the analog signal are captured at discrete instants of time, and are then quantized such that the amplitudes of the analog signals are converted at each sampling instant into a continuous stream of digital speech data. In other words, the acoustic interface 133 converts the analog electrical signals into digital electronic signals. The digital data are binary bits which are buffered in the telematics memory 54 and then processed by the telematics processor 52 or can be processed as they are initially received by the processor 52 in real-time.

Second, the pre-processor module 212 transforms the continuous stream of digital speech data into discrete sequences of acoustic parameters. More specifically, the processor 52 executes the pre-processor module 212 to segment the received speech input into overlapping phonetic or acoustic frames of, for example, 10-30 ms duration. The frames correspond to acoustic subwords such as syllables, demi-syllables, phones, diphones, phonemes, or the like. The pre-processor module 212 also performs phonetic analysis to extract acoustic parameters from the occupant's speech such as time-varying feature vectors, from within each frame. Utterances within the occupant's speech can be represented as sequences of these feature vectors. For example, and as known to those skilled in the art, feature vectors can be extracted and can include, for example, vocal pitch, energy profiles, spectral attributes, and/or cepstral coefficients that can be obtained by performing Fourier transforms of the frames and decorrelating acoustic spectra using cosine transforms. Acoustic frames and corresponding parameters covering a particular duration of speech are concatenated into unknown test pattern of speech to be decoded.

Third, the processor executes the decoder module 214 to process the incoming feature vectors of each test pattern. The decoder module 214 is also known as a recognition engine or classifier, and uses stored known reference patterns of speech.

Like the test patterns, the reference patterns are defined as a concatenation of related acoustic frames and corresponding parameters. The decoder module 214 compares and contrasts the acoustic feature vectors of a subword test pattern to be recognized with stored subword reference patterns, assesses the magnitude of the differences or similarities therebetween, and ultimately uses decision logic to choose a best matching subword as the recognized subword. In general, the best matching subword is that which corresponds to the stored known reference pattern that has a minimum dissimilarity to, or highest probability of being, the test pattern as determined by any of various techniques known to those skilled in the art to analyze and recognize subwords. Such techniques can include dynamic time-warping classifiers, artificial intelligence techniques, neural networks, free phoneme recognizers, and/or probabilistic pattern matchers such as Hidden Markov Model (HMM) engines.

HMM engines are known to those skilled in the art for producing multiple speech recognition model hypotheses of acoustic input. The hypotheses are considered in ultimately identifying and selecting that recognition output which represents the most probable correct decoding of the acoustic input via feature analysis of the speech. More specifically, an HMM engine generates statistical models in the form of an “N-best” list of subword model hypotheses ranked according to HMM-calculated confidence values or probabilities of an observed sequence of acoustic data given one or another subword such as by the application of Bayes' Theorem.

A Bayesian HMM process identifies a best hypothesis corresponding to the most probable utterance or subword sequence for a given observation sequence of acoustic feature vectors, and its confidence values can depend on a variety of factors including acoustic signal-to-noise ratios associated with incoming acoustic data. The HMM can also include a statistical distribution called a mixture of diagonal Gaussians, which yields a likelihood score for each observed feature vector of each subword, which scores can be used to reorder the N-best list of hypotheses. The HMM engine can also identify and select a subword whose model likelihood score is highest. To identify words, individual HMMs for a sequence of subwords can be concatenated to establish word HMMs.

The speech recognition decoder 214 processes the feature vectors using the appropriate acoustic models, grammars, and algorithms to generate an N-best list of reference patterns. As used herein, the term reference patterns is interchangeable with models, waveforms, templates, rich signal models, exemplars, hypotheses, or other types of references. A reference pattern can include a series of feature vectors representative of a word or subword and can be based on particular speakers, speaking styles, and audible environmental conditions. Those skilled in the art will recognize that reference patterns can be generated by suitable reference pattern training of the ASR system and stored in memory. Those skilled in the art will also recognize that stored reference patterns can be manipulated, wherein parameter values of the reference patterns are adapted based on differences in speech input signals between reference pattern training and actual use of the ASR system. For example, a set of reference patterns trained for one vehicle occupant or certain acoustic conditions can be adapted and saved as another set of reference patterns for a different vehicle occupant or different acoustic conditions, based on a limited amount of training data from the different vehicle occupant or the different acoustic conditions. In other words, the reference patterns are not necessarily fixed and can be adjusted during speech recognition.

Using the in-vocabulary grammar and any suitable decoder algorithm(s) and acoustic model(s), the processor accesses from memory several reference patterns interpretive of the test pattern. For example, the processor can generate, and store to memory, a list of N-best vocabulary results or reference patterns, along with corresponding parameter values. Exemplary parameter values can include confidence scores of each reference pattern in the N-best list of vocabulary and associated segment durations, likelihood scores, signal-to-noise ratio (SNR) values, and/or the like. The N-best list of vocabulary can be ordered by descending magnitude of the parameter value(s). For example, the vocabulary reference pattern with the highest confidence score is the first best reference pattern, and so on. Once a string of recognized subwords are established, they can be used to construct words with input from the word models 222 and to construct sentences with the input from the language models 224.

Finally, the post-processor software module 216 receives the output data from the decoder module 214 for any suitable purpose. For example, the post-processor module 216 can be used to convert acoustic data into text or digits for use with other aspects of the ASR system or other vehicle systems. In another example, the post-processor module 216 can be used to provide training feedback to the decoder 214 or pre-processor 212. More specifically, the post-processor 216 can be used to train acoustic models for the decoder module 214, or to train adaptation parameters for the pre-processor module 212.

### Method

A method of dialing phone numbers using an in-vehicle speech recognition system is provided herein and can be carried out as one or more computer programs using the architecture of the ASR system 210 within the operating environment of the vehicle communication system 10 described above. Those skilled in the art will also recognize that the method can be carried out using other ASR systems within other operating environments.

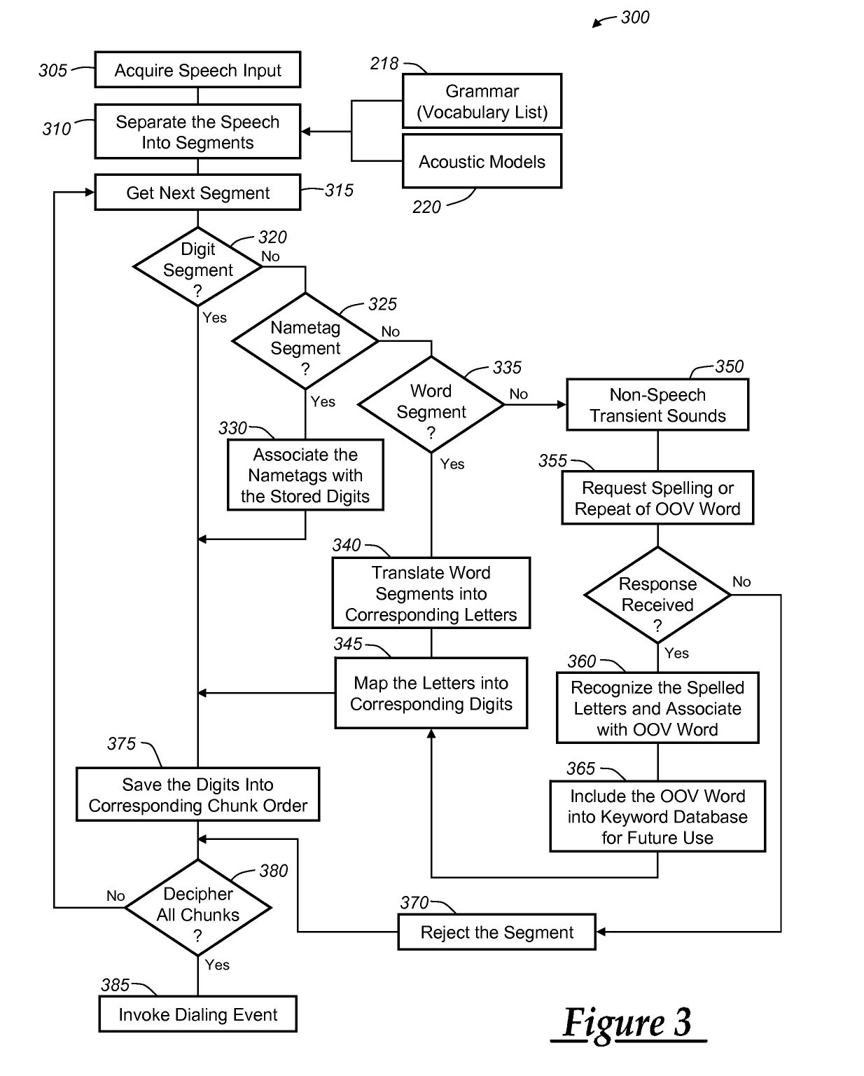

FIG. 3 illustrates an exemplary method 300 of dialing phone numbers using an in-vehicle speech recognition system, as discussed in detail below.

The method 300 begins at step 305 where speech input is received at a vehicle. The speech input can be an enunciated string of words and digits spoken by the user that can be received at the microphone 32 of the vehicle 12. The speech input can include alphanumeric telephone numbers that are often used to help the user remember the telephone number of a business. Speech input can include word segments, digit segments, or the letters of word segments provided by a user. The method then proceeds to step 310.

At step 310, the speech input is separated into a plurality of word segments and digit segments. The ASR system 210 can receive the speech input from the microphone 32 and access the grammar model(s) 218, the acoustic model(s) 220, the word model(s), and/or the language model(s) 224. Using the models 218, 220, 222, and/or 224, the ASR system 210 can identify word segments within the received speech input. In one example, if the received speech input is “1-800-WALMART,” then the ASR system 210 can receive the input and access the grammar model 218, the acoustic model 220, the word model 222, and/or the sentence/language models 224. This example will hereinafter be referred to as the “Walmart” example. Based on the rules in the models 218, 220, 222, 224, the system 210 can separate the speech input into “one eight hundred” and “Walmart.” The ASR system 210, based on the content of the models 218, 220, 222, 224, can identify the segments “one eight hundred” as a digit segment and “Walmart” as a word segment. The method 300 then proceeds to step 315.

At step 315, the method identifies each separated segment for processing. This step begins with the first of the separated segments and continues identifying segments until all of the identified segments are deciphered. In the “Walmart” example, the separated segments can be deciphered in the order in which the user enunciates the segments. For instance, if the separated segments included the segments “one eight hundred” and “Walmart,” the “one eight hundred” segment would be interpreted first, followed by the “Walmart” segment. The method 300 then proceeds to step 320.

At step 320, it is determined if the separated segment is a digit segment. In the Walmart example, the first separated segment deciphered by the method 300 is “one eight hundred.” The method 300 can identify the segment as a digit segment and the method 300 proceeds to step 375. As noted in the description of the exemplary ASR, the system 210 can recognize spoken words, such as “eight” and “hundred,” and identify those words as digits or numbers. Alternatively, when the “Walmart” segment is deciphered, it can be determined that “Walmart” is not a digit segment and the method 300 can proceed to step 325.

At step 325, it is determined if the separated word segment is a nametag. A nametag can be a word segment stored in a database, such as database 84, or in models 218, 220, 222, 224, and linked with a string of digits. The string of digits can be a direct translation of the word string using the DTMF keypad map, as described in an earlier example. On the other hand, the string of digits can be an arbitrary string of digits that bears no direct relationship to the nametag. For example, a nametag “toll-free” could be saved in the database 84. Associated with the nametag “toll-free” and stored with the nametag in the database 84 can be the string of digits “1800.” Modifying the “Walmart” example, if the ASR system 210 received the speech input “toll-free Walmart,” the input can be separated into two word segments, “toll-free” and “Walmart.” And when the word segment “toll-free” is identified as the nametag “toll-free,” the method 300 proceeds to step 330.

At step 330, the nametag is associated with the stored string of digits. The nametag identified at step 325 can be converted to a digit segment based on the digit string stored with the nametag. For instance, the nametag “toll-free” would be translated to “1800” and the method 300 would proceed to step 375. If the word segment is not a nametag, the method 300 proceeds to step 335.

At step 335, it is determined if the separated word segment is identified or confirmed as a word segment by the ASR system 210. Using the “Walmart” example, the system 210 can access the models and reject the word segment “Walmart” as not recognized or contained in the models of the system 210. The method 300 can them proceed to step 350. Or, the system 210 can confirm that the separated word segment “Walmart” is recognized by the models 218, 220, 222, and 224 and the method 300 proceeds to step 340.

At step 340 the word segment is separated or converted into letters. Using the “Walmart” example, the word segment “Walmart” can be separated into “W-A-L-M-A-R-T.” Regardless of the content of the word segment, the word can be translated into a string of individual letters. In one embodiment, word segments can be stored in a database, such as database 84, with the corresponding string of individual letters. After the word segment is recognized using the models 218, 220, 222, and 224, the system 210 can access the database 84 and retrieve the string of letters associated with a particular word segment. In another example, the system 210 can create a string of letters directly from the word segment using the ASR system 210. The method 300 then proceeds to step 345.

At step 345, the string of individual letters is converted to a digit segment. The letters can be converted using the DTMF keypad map mentioned above or any reasonable conversion table that translates letters into digits. Using the DTMF keyboard map and applying the map to “W-A-L-M-A-R-T” renders the digit segment “9256278.” The DTMF keyboard map can be saved in a database, such as database 84, or in the models 218, 220, 222, and 224 of system 210. When analyzing the string of individual letters, the system 210 can iterate through the string of letters and compare each letter with the DTMF keyboard map. Alternatively, the processing device 52 of the telematics device 30 can iterate through the string of letters. The method 300 then proceeds to step 375. If the system 210 determined that the word segment in step 335 was not recognized as a word segment or was not contained in the models 218, 220, 222, and 224 of the system 210, the method 300 can them proceed to step 350.

At step 350, the word segment is classified as non-speech transient sound.

Transient sounds include vehicle and road noise that includes the operational sounds of turn signals, windshield wipers/washers, hazard signals, door locks, and vehicle horns. If the separated word segment is not recognized by the system 210, the separated word segment can be classified as transient sound and the method can proceed to step 355.

At step 355, a user is prompted to spell or re-enunciate the separated word segment identified as a non-speech transient sound. In some cases, the system 210 may incorrectly classify or reject a valid word segment. In order to increase the accuracy of the method 300, the user can be prompted to spell the non-speech transient sound in case the system 210 made an error. The user can also be prompted to repeat the transient sound without spelling. For instance, if the system 210 mistakenly classified a word segment as a transient sound, the user can be prompted to spell the mistakenly classified word segment. Spelling the word segment can establish a string of letters and be processed in a similar fashion to the string of letters in step 345. If the user fails to respond the prompt, the method proceeds to step 370, where the word segment is rejected and the method continues to step 380. Otherwise, the method 300 then proceeds to step 360.

At step 360, the string of letters is recognized. The string of letters provided by the user to the prompt can be identified as a new nametag, a new word segment, or can be associated with the mistakenly classified word segment. The method then proceeds to step 365.

At step 365, the new nametag, new word segment, or mistakenly classified word segment is recorded and associated with the string of letters. In one example, the mistakenly classified word segment, also referred to as an “out of vocabulary” word (OOV), will be saved in database 84 or the models 218, 220, 222, 224 with the string of letters. In order to prevent the system 210 from mistakenly classifying word segments in the future and prompting the user to repeat or spell the mistakenly classified word segment, the new nametag, new word segment, or mistakenly classified word segment can be stored in the database 84 or models 218, 220, 222, and 224, or any other suitable memory space with the string of letters. The result of storing the new nametag, new word segment, or mistakenly classified word segment in the models 218, 220, 222, and 224 helps the system 210 recognize the mistakenly rejected word segment and reduce errors in the future. The method proceeds to step 345 where the string of letters associated with the new nametag, new word segment, or mistakenly classified word segment is mapped as described.

At step 375, the digit segments, the nametags converted into digit segments, and word segments converted to digit segments are received and saved. The digit segments can be saved in the order in which they are received or processed. The digit segments can be saved in a database, such as database 84, or in an EEPROM or other non-volatile memory (not shown), for later access. The method then proceeds to step 380.

At step 380, it is determined if all of the segments separated in step 310 have been deciphered. Or in other words, it is determined if all of the separated segments from step 310 have been converted or presently exist as digit segments. If not, the method proceeds to step 315. Otherwise, the method proceeds to step 385.

At step 385, a dialing event is invoked. The digit segments saved in step 375 can be accessed and using the telematics unit 30 of the vehicle 12, the digit segments can be dialed and a phone call connected via the wireless network 14. The method then ends.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of dialing phone numbers using an in-vehicle speech recognition system, the method comprising:
(a) receiving speech input at a vehicle;
(b) separating the speech input into a word segment and a digit segment;
(c) identifying the letters in a word segment;
(d) converting the letters in the word segment to digits; and
(e) operating an alphanumeric keypad based on the digit segment and the converted word segment.

2. The method of claim 1, wherein speech input is an alphanumeric string of digits and characters.

3. The method of claim 1, wherein separating the speech input of step (b) comprises invoking a vocabulary database and comparing word segments.

4. The method of claim 1, further comprising the step of identifying non-speech segments.

5. The method of claim 1, wherein the number of word segments in step (b) is determined by the number of times the speech input changes from digit segments to word segments and the speech input is parsed.

6. The method of claim 2, wherein the vocabulary database further comprises nametags that are words corresponding to a stored digit segment.

7. The method of claim 3, wherein comparing word segments comprises comparing the word segments received as speech input to word segments stored in the vocabulary database.

8. The method of claim 3, wherein the vocabulary database includes word segments mapped to alphabet letters.

9. The method of claim 6, wherein the stored digit segment does not match letters on an alphanumeric keypad to the nametag.

10. The method of claim 8, wherein the alphabet letters are mapped to digits.

11. A method of dialing phone numbers using an in-vehicle speech recognition system, the method comprising:
(a) receiving speech input at a vehicle;
(b) separating the speech input into a plurality of word segments and digit segments;
(c) recording the order of the word segments and digit segments;
(d) identifying the letters in a word segment;
(e) converting the letters in the word segment to a digit segment;
(f) organizing the digit segments and converted word segments into a single string of digits, wherein the sequence of the single string of digits is based on the recorded order of the word segments and digit segments; and
(g) dialing a telephone number using the single string of digits.

12. The method of claim 11, wherein speech input is an alphanumeric string of digits and characters.

13. The method of claim 11, wherein separating the speech input of step (b) comprises invoking a vocabulary database and comparing stored word segments with the received speech input.

14. The method of claim 13, wherein the vocabulary database includes stored word segments mapped to alphabet letters or a digit segment.

15. The method of claim 14, further comprising the step of comparing the separated word segments to the stored word segments.

16. The method of claim 14, wherein the vocabulary database further comprises nametags that are words corresponding to a stored digit segment.

17. The method of claim 16, wherein the stored digit segment is arbitrarily related to the nametag.

18. The method of claim 11, further comprising the step of identifying non-speech segments.

19. A method of dialing phone numbers using an in-vehicle speech recognition system, the method comprising:
(a) receiving speech input at a vehicle;
(b) separating the speech input into a plurality of word segments and digit segments;
(c) recording the order of the word segments and digit segments;
(d) comparing the plurality of word segments with the content of a vocabulary database, wherein the database contains nametags stored with a string of digits and stored word segments;
(e) if the word segment matches a nametag stored in the vocabulary database, translating the word segment into the string of digits;
(f) if a separated word segment matches a stored word segment, translating the letters of the separated word segment into digits corresponding to the letters of an alphanumeric keypad;
(g) requesting user input if the vocabulary database fails to recognize a word segment;
(h) organizing the translated digit segments and converted word segments into a single string of digits, wherein the sequence of the single string of digits is based on the recorded order of the word segments and digit segments; and
(i) dialing a telephone number using the single string of digits.

20. The method of claim 19, wherein the user input of step (g) further comprises a user verbally enunciating the letters of the word segment.
